(19) United States
(12) Patent Application Publication
(10) Pub. No.: US 2023/0215671 A1
(43) Pub. Date: Jul. 6, 2023

(54) THERMAL OVERLOAD RELAY

(71) Applicant: FUJI ELECTRIC FA COMPONENTS & SYSTEMS CO., LTD., Saitama (JP)

(72) Inventors: Takeo KAMOSAKI, Kounosu-City (JP); Yuma ONOGI, Kounosu-City (JP); Hayato MIURA, Kounosu-City (JP)

(73) Assignee: FUJI ELECTRIC FA COMPONENTS & SYSTEMS CO., LTD., Saitama (JP)

(21) Appl. No.: 18/177,411

(22) Filed: Mar. 2, 2023

Related U.S. Application Data
(63) Continuation of application No. PCT/JP2022/021039, filed on May 23, 2022.

(30) Foreign Application Priority Data
Jul. 2, 2021 (JP) 2021-110646

(51) Int. Cl. H01H 37/54; H01H 37/70; H01H 37/00; H01H 37/04

(52) U.S. Cl. CPC H01H 37/5409; H01H 37/002; H01H 37/04; H01H 37/70

(57) ABSTRACT

A case has an engagement hole formed in a side surface thereof in the width direction, a cover has a projecting piece formed thereon, the projecting piece projecting toward the case side, and a tip portion of the projecting piece is fitted into the engagement hole from the inside. A reset bar has a recessed portion formed in a preset range extending in the depth direction and the circumferential direction within the outer peripheral surface of the reset bar and, when positioned at either an initial position or an automatic reset position, prevents the tip portion from being pushed inside by having the outer peripheral surface opposed to the back side of the projecting piece. In addition, when positioned at a manual reset position, the reset bar allows the tip portion to be pushed inside by having the recessed portion opposed to the back side of the projecting piece.

### CROSS-REFERENCE TO RELATED APPLICATION

This application is a continuation application filed under 35 U.S.C. § 111(a) of International Patent Application No. PCT/JP2022/021039, filed on May 23, 2022, the contents of which are incorporated herein by reference.

### TECHNICAL FIELD

The present disclosure relates to a thermal overload relay.

### BACKGROUND ART

A thermal overload relay (thermal relay) trips when overcurrent keeps flowing because a bimetal bends due to heat and, by turning off an electromagnetic contactor, protects a main circuit from overload. A thermal overload relay disclosed in JP 2014-107023 A has a structure in which a cover is attached to a case by hooking a hook of the cover into an engagement hole of the case.

### SUMMARY OF INVENTION

### Technical Problem

When a screw terminal located close to the engagement hole of the case is tightened or loosened, there is a possibility that a force is exerted to the hook of the cover and the hook is accidentally released. Although, for that reason, it is conceivable that a barrier wall that prevents the hook from bending to the back side of the case is disposed, when configured in this manner, it is required to destroy the hook to remove the cover, and the cover becomes unable to be reused.

An object of the present disclosure is to, in a thermal overload relay, enable attachment and detachment of a cover and prevent engagement of the cover from being accidentally released when torque is applied to a screw terminal.

### Solution to Problem

According to an aspect of the present disclosure, there is provided a thermal overload relay including: a case on which a screw terminal having an axial direction aligned with a depth direction is disposed and in a side surface of which in a width direction when viewed from the depth direction an engagement hole is formed; a cover on which a projecting piece projecting toward the case is formed and to be attached to the case by a tip portion of the projecting piece being fitted into the engagement hole from an inside; and a reset bar having an axial direction aligned with the depth direction and configured to, when displaced to a manual reset position, the manual reset position being a position to which the reset bar is only displaced by being pushed from a front side in the depth direction serving as an initial position to a rear side in the depth direction, restore the thermal overload relay from a tripped state and, when displaced to an automatic reset position, the automatic reset position being a position at which a position in the depth direction of the reset bar is maintained by the reset bar being pushed and displaced from the initial position to a rear side in the depth direction and being rotated about an axis, automatically restore the thermal overload relay from the tripped state, wherein the reset bar has a recessed portion formed in a preset range extending in the depth direction and a circumferential direction within an outer peripheral surface of the reset bar and, when positioned at either the initial position or the automatic reset position, prevents the tip portion from being pushed inside by having the outer peripheral surface opposed to the projecting piece and, when positioned at the manual reset position, allows the tip portion to be pushed inside by having the recessed portion opposed to the projecting piece.

### Advantageous Effects of Invention

According to the present disclosure, when the reset bar is positioned at the manual reset position, the tip portion of the projecting piece being pushed inside causes the tip portion to be released from the engagement hole, which enables the cover to be removed. In contrast, when the reset bar is positioned at the initial position or the automatic reset position, the cover cannot be removed because the tip portion of the projecting piece is prevented from being pushed inside. It is when the reset bar is positioned at the initial position or the automatic reset position that torque is applied to a screw terminal by wiring operation, and the cover cannot be removed on this occasion. Therefore, the present disclosure enables attachment and detachment of the cover and also enables engagement of the cover to be prevented from being accidentally released when torque is applied to a screw terminal.

### BRIEF DESCRIPTION OF DRAWINGS

FIG. 1 is a diagram illustrative of a thermal overload relay;

FIG. 2 is a diagram illustrative of a state in which a cover is removed from a case;

FIG. 3 is a diagram illustrative of the inside of the case from which the cover is removed;

FIGS. 4A and 4B are diagrams illustrative of a reset bar;

FIG. 5 is a diagram illustrative of an initial position;

FIGS. 6A and 6B are diagrams illustrative of a manual reset position and an automatic reset position;

FIGS. 7A and 7B are diagrams illustrative of the initial position;

FIGS. 8A and 8B are diagrams illustrative of the manual reset position and the automatic reset position;

FIGS. 9A and 9B are diagrams illustrative of a comparative example; and

FIG. 10 is a diagram illustrative of a variation.

### DESCRIPTION OF EMBODIMENTS

Hereinafter, embodiments of the present disclosure are described with reference to the drawings. It should be noted that each drawing is schematic and may not be the same as actual one. Additionally, the embodiments given below exemplify devices and methods for embodying the technological concept of the present disclosure, and do not limit components of the disclosure to those below. In other words, various modifications can be added to the technological concept of the present disclosure without departing from the technological scope described in the appended claims.

### (One Embodiment)

### (Configuration)

In the following description, three directions orthogonal to one another are set to the vertical direction, the width direction, and the depth direction for descriptive purposes.

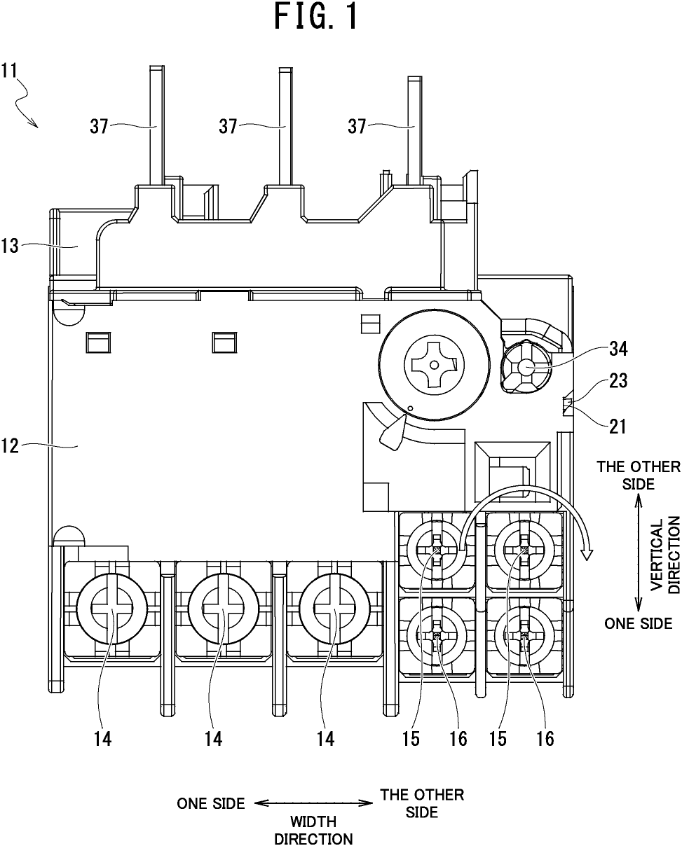

FIG. 1 is a diagram illustrative of a thermal overload relay.

In FIG. 1, the thermal overload relay viewed from the front side in the depth direction is illustrated. A thermal overload relay 11 is also referred to as a thermal relay, and trips when overcurrent keeps flowing and, by turning off a not-illustrated electromagnetic contactor, protects a main circuit from overload. The thermal overload relay 11 includes a case 12 and a cover 13.

The case 12 includes main terminals 14, auxiliary terminals 15, and auxiliary terminals 16. All the terminals are screw terminals the axial directions of which are aligned with the depth direction, and tightening torque is applied in the clockwise direction when viewed from the front side in the depth direction, as illustrated by a circular block arrow.

Three main terminals 14 are arranged side by side along the width direction on one side in the vertical direction and one side in the width direction on the case 12.

Two auxiliary terminals 15 are arranged side by side along the width direction on one side in the vertical direction, the other side in the width direction, and the front side in the depth direction on the case 12. The auxiliary terminals 15 are an a-contact that is normally open.

Two auxiliary terminals 16 are arranged side by side along the width direction on one side in the vertical direction of the auxiliary terminals 15, the other side in the width direction, and the rear side in the depth direction on the case 12. The auxiliary terminals 16 are a b-contact that is normally closed.

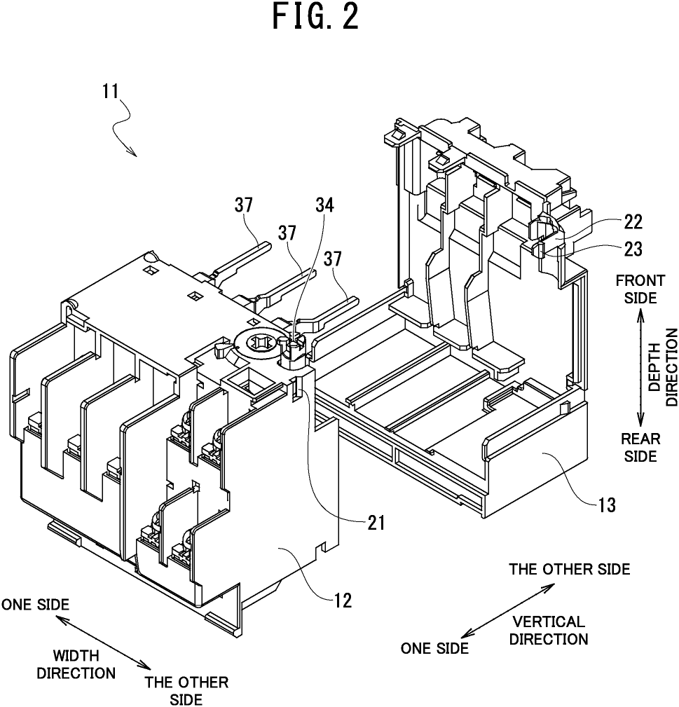

FIG. 2 is a diagram illustrative of a state in which the cover is removed from the case.

The case 12 opens to the the other side in the vertical direction and the rear side in the depth direction. The cover 13 is substantially L-shaped when viewed from one side in the width direction and, by being fitted to the case 12 in the vertical direction, closes the other side in the vertical direction and the rear side in the depth direction of the case 12. In the case 12, an engagement hole 21 penetrating through the case 12 in the width direction is formed on the front side in the depth direction within a side surface on the other side in the width direction, and, on the cover 13, a projecting piece 22 projecting toward one side in the vertical direction is formed on the front side in the depth direction.

The projecting piece 22 is formed in a substantially plate shape extending in the vertical direction and the depth direction, and a tip portion 23 of the projecting piece 22 is formed in a hook shape that protrudes toward the other side in the width direction and fits into the engagement hole 21 from the inside. The engagement hole 21 and the projecting piece 22 are configured in a snap-fit structure. That is, when the cover 13 is attached to the case 12, the tip portion 23 of the projecting piece 22 is pushed by the inner peripheral surface of the case 12 and the projecting piece 22 is caused to bend. When the tip portion 23 is fitted into the engagement hole 21 and the projecting piece 22 is restored to the original shape, the cover 13 is fixed to the case 12. On the other hand, when the projecting piece 22 is caused to bend by the tip portion 23 that has been fitted into the engagement hole 21 being pushed inside by a tool, such as a screwdriver, and the tip portion 23 is released from the engagement hole 21, the cover 13 can be removed from the case 12. Note that, although the case 12 and the cover 13 include a plurality of snap-fit structures at other locations, detailed description of the snap-fit structures will be omitted because the snap-fit structures are not major constituent components of the embodiment and are general structures.

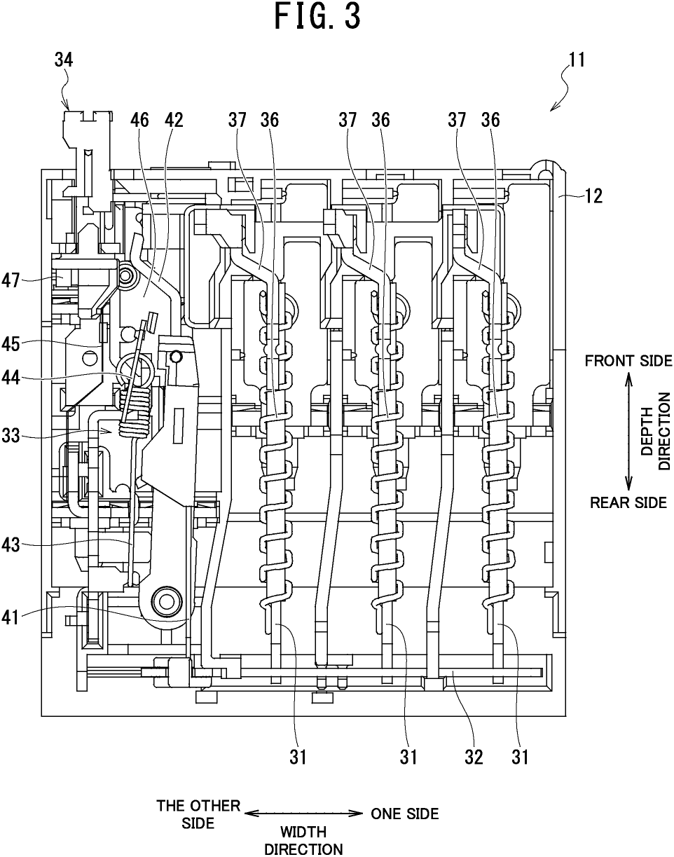

FIG. 3 is a diagram illustrative of the inside of the case from which the cover is removed.

In FIG. 3, the inside of the case 12 viewed from the other side in the vertical direction is illustrated. Inside the case 12, bimetals 31, a shifter 32, a reversal mechanism 33, and a reset bar 34 are included.

Each of the bimetals 31 is formed in a plate shape along the vertical direction and the depth direction that extends in the depth direction, and the front side and the rear side in the depth direction of the bimetal 31 are a fixed end and a free end, respectively. Each of the bimetals 31 has the front side in the depth direction connected to one of the main terminals 14 and the rear side in the depth direction bonded to one end of one of heaters 36. Each of the heaters 36 is wound around one of the bimetals 31 and has the other end thereof bonded to one of connection terminals 37 on the front side in the depth direction. The connection terminals 37 are connected to a not-illustrated electromagnetic contactor. Although each of the bimetals 31 has a straight line shape under normal conditions, the free end side of the bimetal 31 bends to the other side in the width direction and pushes the shifter 32 when the main circuit is brought into an overload state.

The shifter 32 is an insulator, is formed in a flat plate shape extending in the width direction and the vertical direction, and is supported by the case 12 in an advanceable and retractable manner in the width direction. The shifter 32 is engaged with the free ends of the bimetals 31 and, although positioned on one side in the width direction under normal conditions, is displaced to the other side in the width direction caused by bending of the bimetals 31 when the main circuit is brought into an overload state.

The reversal mechanism 33 is a mechanism that, when overload is detected, reverses the states of contacts, that is, closes the a-contact and opens the b-contact, and includes a compensation bimetal 41, a release lever 42, a tension spring 43, a movable plate 44, a plate spring 45, and an interlocking plate 46. Only an overview of the reversal mechanism 33 will be described because the reversal mechanism 33 is not a major constituent component of the embodiment.

The compensation bimetal 41 is formed in a plate shape along the depth direction and the vertical direction that extends in the depth direction, has the front side in the depth direction fixed to the release lever 42, and has the rear side in the depth direction serving as a free end and engaging with the shifter 32.

The release lever 42 is formed in a plate shape along the depth direction and the vertical direction that extends in the depth direction, is rotatably supported by a fulcrum shaft extending in the vertical direction, and has the rear side in the depth direction in contact with the tension spring 43.

The tension spring 43 pulls the movable plate 44 toward the rear side in the depth direction.

The movable plate 44 is formed in a flat plate shape extending in the depth direction and the vertical direction, and the front side in the depth direction of the movable plate 44 is displaceable in the width direction with the rear side in the depth direction thereof as a fulcrum. A position at which the movable plate 44 stands upright is a dead point of the movable plate 44, and, when a force toward one side or the other side in the width direction is exerted, the movable plate 44 is inclined to one side or the other side in the width direction by tensile force of the tension spring 43. Although the movable plate 44 is inclined to one side in the width direction under normal conditions, the movable plate 44 is inclined to the other side in the width direction by being pushed by the release lever 42 via the compensation bimetal 41 when the main circuit is brought into an overload state. The movable contact piece 44 has the rear side in the depth direction connected to one of the auxiliary terminals 15 and has a movable contact formed on the front side in the depth direction thereof.

The plate spring 45 is formed in a flat plate shape along the depth direction and the vertical direction that extends in the depth direction, has the rear side in the depth direction connected to the other of the auxiliary terminals 15, and has a fixed contact formed on the front side in the depth direction thereof that is opposed to the movable plate 44. Although the movable contact of the movable plate 44 is separated from the fixed contact of the plate spring 45 under normal conditions, the movable contact of the movable plate 44 comes into contact with the fixed contact of the plate spring 45 caused by inclination of the movable plate 44 to the other side in the width direction when the main circuit is brought into an overload state. The fixed contact and the movable contact constitute the a-contact, and the thermal overload relay 11 is put into a tripped state when the a-contact is closed.

The interlocking plate 46 is formed in a plate shape extending in the width direction and the depth direction, is rotatably supported by a fulcrum shaft extending in the vertical direction, and has the rear side in the depth direction engaged with the movable plate 44. The interlocking plate 46 rotates in an interlocking manner with the movement of the movable plate 44 and thereby opens and closes a contact on the back side of the interlocking plate 46, which is not illustrated in the drawings. That is, although a movable contact is in contact with a fixed contact under normal conditions, the interlocking plate 46 rotates and thereby causes the movable contact to be separated from the fixed contact when the main circuit is brought into an overload state. The fixed contact and the movable contact constitute the b-contact, and the thermal overload relay 11 is put into a tripped state when the b-contact is opened.

The reset bar 34 is a manipulator to restore the thermal overload relay 11 from a tripped state to a normal state, is formed in a substantially cylindrical shape the axial direction of which is aligned with the depth direction, and is arranged on the other side in the vertical direction, on the other side in the width direction, and in a vicinity of the engagement hole 21 on the case 12. The reset bar 34 is supported by the case 12 while being displaceable in the depth direction and rotatable about the axis thereof and is further biased to the front side in the depth direction by a plate spring 47 extending in the vertical direction. For the reset bar 34, an initial position, a manual reset position, and an automatic reset position are defined. The initial position is a position illustrated in FIG. 3 at which the front side in the depth direction of the reset bar 34 projects out of the case 12. The manual reset position is a position to which the reset bar 34 is only displaced from the initial position by being pushed to the rear side in the depth direction. The automatic reset position is a position at which the position in the depth direction of the reset bar 34 is maintained by the reset bar 34 being pushed and displaced from the initial position to the rear side in the depth direction and being rotated approximately 90 degrees in a clockwise direction when viewed from the front side in the depth direction.

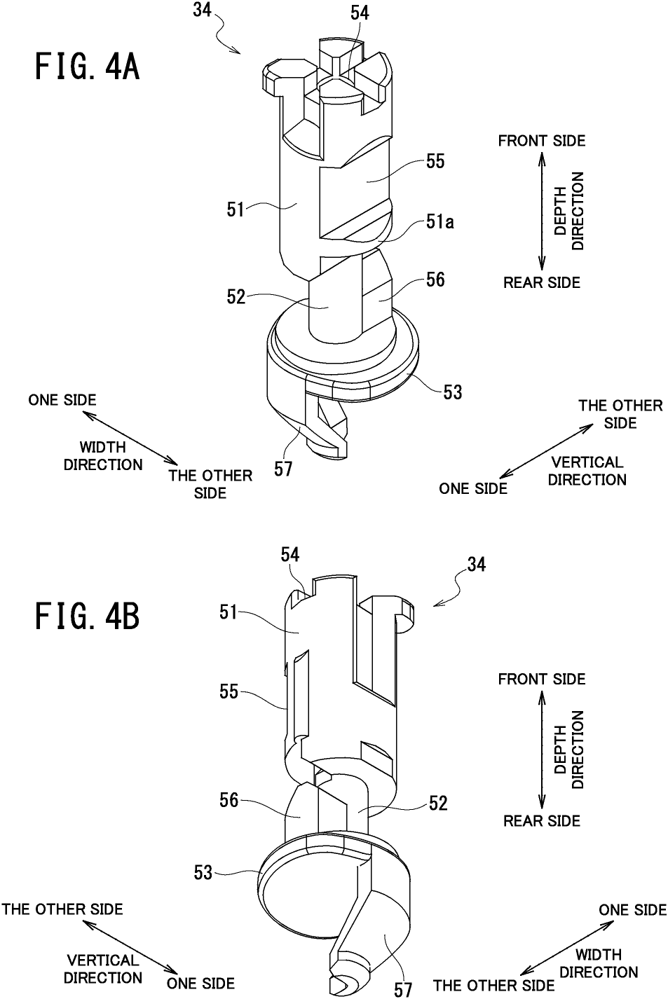

FIGS. 4A and 4B are diagrams illustrative of the reset bar.

FIG. 4A illustrates the reset bar 34 positioned at the initial position that is viewed from one side in the vertical direction, the other side in the width direction, and the front side in the depth direction. FIG. 4B illustrates the reset bar 34 positioned at the initial position that is viewed from the other side in the vertical direction, one side in the width direction, and the rear side in the depth direction.

The reset bar 34 includes a head portion 51, a neck portion 52, and a bottom portion 53 in this order from the front side toward the rear side in the depth direction.

The head portion 51 is substantially cylindrically shaped, and, at the end thereof on the front side in the depth direction, a cross-shaped groove 54 into which a tool, such as a Phillips screwdriver, fits is formed. On the other side in the width direction of the outer peripheral surface of the head portion 51, a recessed portion 55 recessed toward one side in the width direction is formed. The recessed portion 55 is a shallow recess extending in the vertical direction, and a bottom surface of the recessed portion 55, by being formed in a flat surface extending in the vertical direction and the depth direction, forms a chord of the outer peripheral surface of the head portion 51 when viewed from the depth direction. A dimension in the depth direction of the recessed portion 55 is greater than a dimension in the depth direction of the projecting piece 22. In addition, a maximum depth in the width direction of the recessed portion 55 is approximately equal to a maximum height in the width direction of the tip portion 23. The maximum depth in the width direction of the recessed portion 55 is a depth from a point located on the most other side in the width direction within the outer peripheral surface of the head portion 51. The maximum height in the width direction of the tip portion 23 is a height from an end surface on the other side in the width direction on the projecting piece 22. The recessed portion 55 being formed causes a projecting portion 51a to be formed on the rear side in the depth direction of the recessed portion 55 on the outer peripheral surface of the head portion 51. Although the projecting portion 51a projects to the other side in the width direction with respect to the bottom surface of the recessed portion 55, the projecting portion 51a is a part of the outer peripheral surface of the head portion 51.

The neck portion 52 is formed in a substantially cylindrical shape that is coaxial with the head portion 51 and has a smaller diameter than the head portion 51, and, on the rear side in the depth direction of the outer peripheral surface of the neck portion 52, a latch portion 56 that projects to the other side in the vertical direction is formed. The latch portion 56 has a surface on the radially outer side formed along the outer peripheral surface of the head portion 51, and a dimension in the width direction of the latch portion 56 when viewed from the other side in the vertical direction is slightly smaller than the outer diameter of the neck portion 52. The latch portion 56 is separated in the depth direction from an end surface on the rear side in the depth direction of the head portion 51.

The bottom portion 53 is formed in a substantially disk shape that has a larger diameter than the neck portion 52, and the plate spring 47 coming into contact with an end surface on the rear side in the depth direction of the bottom portion 53 causes the reset bar 34 to be biased to the front side in the depth direction. On the bottom portion 53, a base piece 57 protruding toward the rear side in the depth direction is formed. The base piece 57 is formed in a substantially conical cylindrical shape the diameter of which becomes smaller toward the rear side in the depth direction and is formed in a range of approximately 90 degrees from one side in the vertical direction to one side in the width direction within the circumference of the bottom portion 53, and a portion on the front side in the depth direction of the plate spring 45 comes into contact with a conical surface on the outer peripheral side of the base piece 57.

Next, the positions of the reset bar 34 will be described.

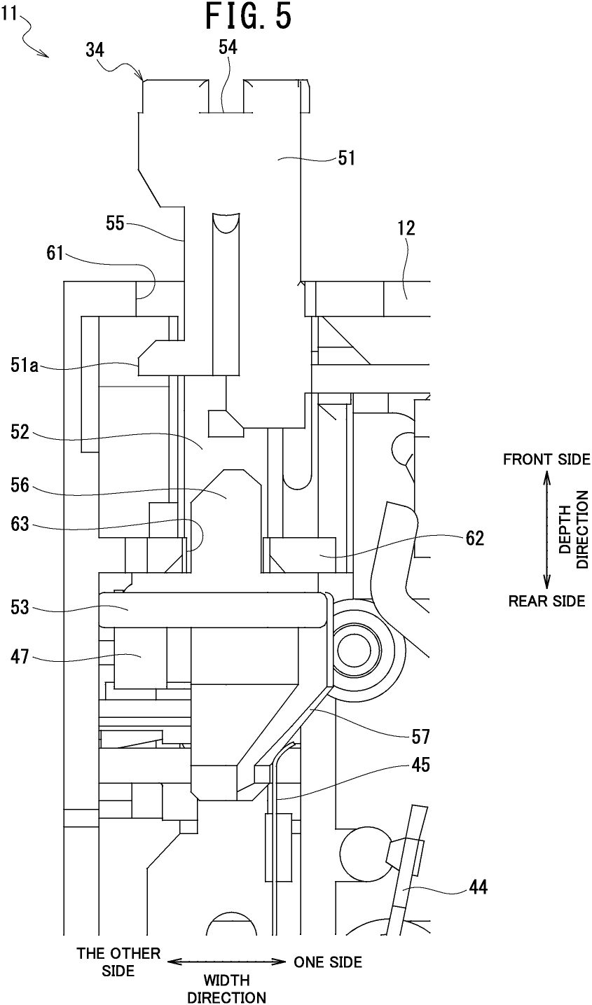

FIG. 5 is a diagram illustrative of the initial position.

On the other side in the width direction of an outer wall on the front side in the depth direction of the case 12, a recessed groove 61 that is substantially U-shaped when viewed from the depth direction and is recessed toward one side in the vertical direction is formed. The recessed groove 61 is slightly larger than the outer diameter of the head portion 51 of the reset bar 34. On the rear side in the depth direction of the recessed groove 61 inside the case 12, a partition wall 62 that extends in the width direction and the vertical direction is formed, and, on the partition wall 62, a recessed groove 63 that is substantially U-shaped when viewed from the depth direction and is recessed toward one side in the vertical direction is formed. The thickness of the partition wall 62 is slightly smaller than a gap in the depth direction between the head portion 51 and the latch portion 56, and the recessed groove 63 is slightly larger than the outer diameter of the neck portion 52 of the reset bar 34. Into the recessed groove 61 and the recessed groove 63, the reset bar 34 is fitted. The reset bar 34, by being biased to the front side in the depth direction by the plate spring 47, has the bottom portion 53 in contact with the partition wall 62, and this position serves as the initial position. Since, on this occasion, the latch portion 56 is also fitted into the recessed groove 63 in conjunction with the neck portion 52, the reset bar 34 is prevented from being rotated about the axis thereof.

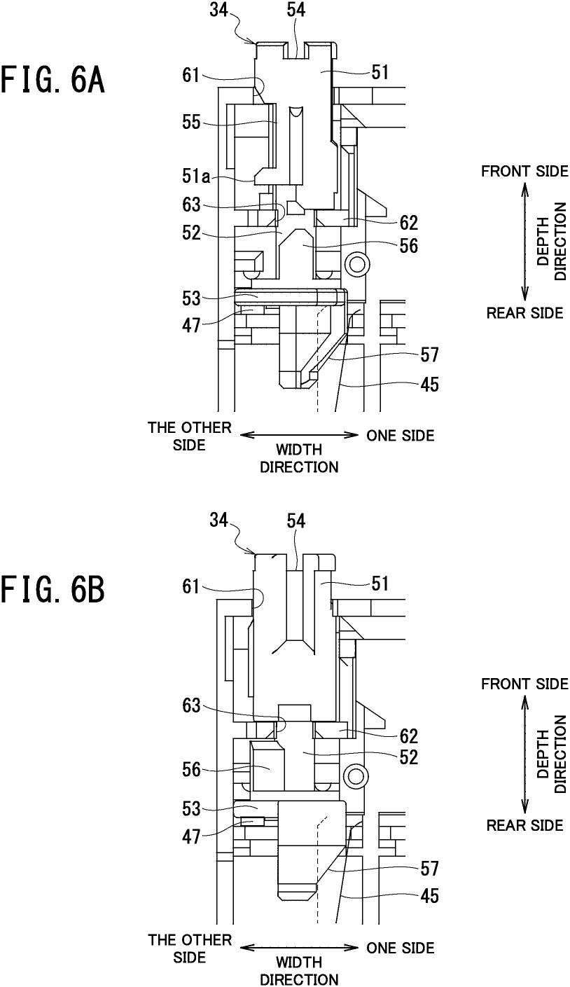

FIGS. 6A and 6B are diagrams illustrative of the manual reset position and the automatic reset position.

FIG. 6A illustrates the manual reset position of the reset bar 34. Since, when the reset bar 34 is pushed to the rear side in the depth direction while the thermal overload relay 11 is in a tripped state, the plate spring 45 and the movable plate 44 are pushed to one side in the width direction by the base piece 57, the thermal overload relay 11 opens the a-contact and closes the b-contact again if an overload state is eliminated

FIG. 6B illustrates the automatic reset position of the reset bar 34. When the reset bar 34 is pushed to the rear side in the depth direction and is rotated approximately 90 degrees in the clockwise direction when viewed from the front side in the depth direction while the thermal overload relay 11 is in a tripped state, the latch portion 56 coming into contact with the rear side in the depth direction of the partition wall 62 causes the position of the reset bar 34 in the depth direction to be maintained. In addition, since the plate spring 45 and the movable plate 44 are pushed to one side in the width direction by the base piece 57, the thermal overload relay 11 automatically opens the a-contact and closes the b-contact again when an overload state is eliminated.

Next, removal of the cover 13 will be described.

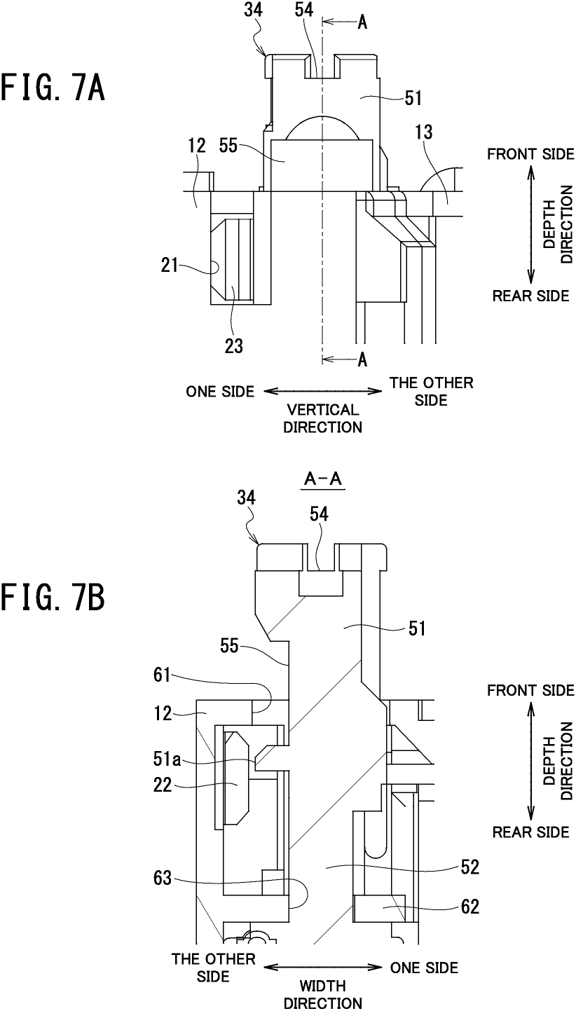

FIGS. 7A and 7B are diagrams illustrative of the initial position.

FIG. 7A illustrates the case 12 on which the cover 13 is attached that is viewed from the other side in the width direction. Into the engagement hole 21 of the case 12, the tip portion 23 of the projecting piece 22 formed on the cover 13 is fitted from the inside.

FIG. 7B illustrates a cross section taken along the line A-A of FIG. 7A that crosses the reset bar 34 and extends in the width direction and the depth direction. When the reset bar 34 is positioned at the initial position, the projecting portion 51a that is located on the rear side in the depth direction of the recessed portion 55 within the outer peripheral surface of the head portion 51 is opposed to the back side of the projecting piece 22. Thus, even when the tip portion 23 is pushed inside, the back surface of the projecting piece 22 interferes with the outer peripheral surface of the head portion 51, which prevents the tip portion 23 from being pushed to the inner side. Therefore, it becomes impossible to remove the cover 13 from the case 12. For a similar reason, it also becomes impossible to attach the cover 13 to the case 12.

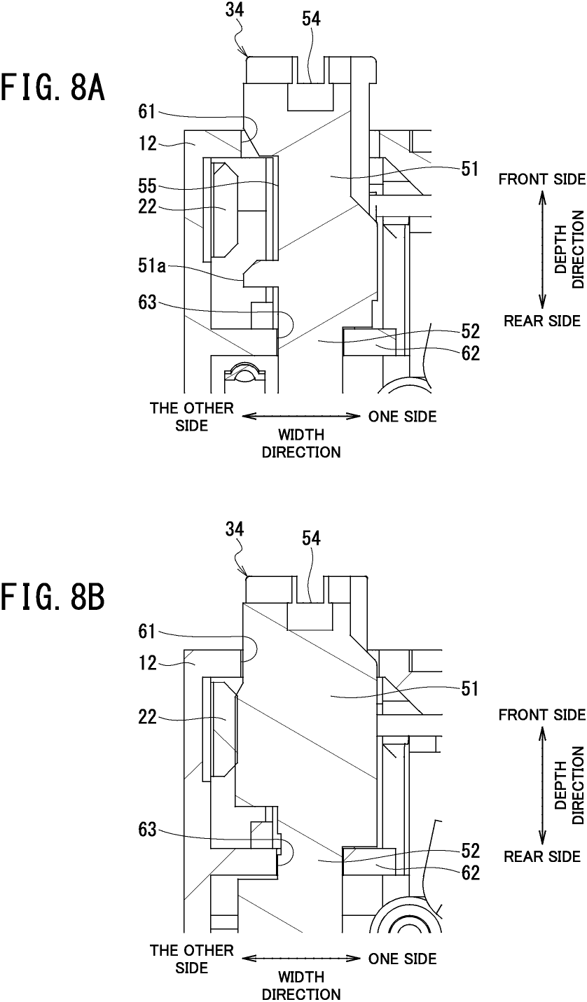

FIGS. 8A and 8B are diagrams illustrative of the manual reset position and the automatic reset position.

FIG. 8A illustrates a cross section that crosses the reset bar 34 positioned at the manual reset position and extends in the width direction and the depth direction. When the reset bar 34 is positioned at the manual reset position, the recessed portion 55 of the head portion 51 is opposed to the back side of the projecting piece 22. Thus, when the tip portion 23 is pushed inside, the projecting piece 22 enters the recessed portion 55 and the tip portion 23 is allowed to be pushed to the inner side. Therefore, it becomes possible to remove the cover 13 from the case 12. For a similar reason, it also becomes possible to attach the cover 13 to the case 12.

FIG. 8B illustrates a cross section that crosses the reset bar 34 positioned at the automatic reset position and extends in the width direction and the depth direction. When the reset bar 34 is positioned at the automatic reset position, the outer peripheral surface of the head portion 51 is opposed to the back side of the projecting piece 22. Thus, even when the tip portion 23 is pushed inside, the back surface of the projecting piece 22 interferes with the outer peripheral surface of the head portion 51, which prevents the tip portion 23 from being pushed to the inner side. Therefore, it becomes impossible to remove the cover 13 from the case 12. For a similar reason, it also becomes impossible to attach the cover 13 to the case 12.

### (Advantageous Effects)

Next, main advantageous effects of the one embodiment will be described.

The thermal overload relay 11 includes the case 12, the cover 13, and the reset bar 34. The case 12 has screw terminals the axial directions of which are aligned with the depth direction disposed thereon, opens to the side that is to be connected to the electromagnetic contactor, and has the engagement hole 21 formed on a side surface in the width direction when viewed from the depth direction. The cover 13 has the projecting piece 22 that projects toward the case 12 formed thereon and is attached to the open side of the case 12 by the tip portion 23 of the projecting piece 22 being fitted into the engagement hole 21 from the inside. The reset bar 34 has the axial direction aligned with the depth direction and, when displaced to the manual reset position, which is a position to which the reset bar 34 is only displaced by being pushed from the front side in the depth direction serving as the initial position to the rear side in the depth direction, restores the thermal overload relay 11 from the tripped state. In addition, when displaced to the automatic reset position, which is a position at which the position in the depth direction of the reset bar 34 is maintained by the reset bar 34 being pushed and displaced from the initial position to the rear side in the depth direction and being rotated about the axis thereof, the reset bar 34 automatically restores the thermal overload relay 11 from the tripped state. The reset bar 34 has the recessed portion 55 formed in a preset range extending in the depth direction and the circumferential direction within the outer peripheral surface thereof and, when positioned at either the initial position or the automatic reset position, prevents the tip portion 23 of the projecting piece 22 from being pushed inside by having the outer peripheral surface thereof opposed to the back side of the projecting piece 22. When positioned at the manual reset position, the reset bar 34 allows the tip portion 23 of the projecting piece 22 to be pushed inside by having the recessed portion 55 thereof opposed to the back side of the projecting piece 22.

Therefore, when the reset bar 34 is positioned at the manual reset position, the tip portion 23 of the projecting piece 22 being pushed inside causes the tip portion 23 having been fitted into the engagement hole 21 to be released and enables the cover 13 to be removed. In contrast, when the reset bar 34 is positioned at the initial position or the automatic reset position, the cover 13 cannot be removed because the tip portion 23 of the projecting piece 22 is prevented from being pushed inside. It is when the reset bar 34 is positioned at the initial position or the automatic reset position that torque is applied to a screw terminal by wiring operation, and the cover 13 cannot be detached on this occasion. Therefore, it is possible to enable the cover 13 to be attached and detached and, at the same time, prevent engagement of the cover 13 from being accidentally released when torque is applied to a screw terminal. In addition, since there is no possibility that the projecting piece 22 or the tip portion 23 is destroyed, it is possible to avoid a situation in which a broken piece is left inside the case 12.

A side surface in which the engagement hole 21 is formed is a side surface on, between one side and the other side in the width direction, the side on which torque applied to a screw terminal is exerted from the inner side to the outer side in the width direction on the open side of the case 12 when viewed from the front side in the depth direction. For example, in the case of tightening torque, the side surface in which the engagement hole 21 is formed is the side surface on the other side in the width direction, as illustrated in FIG. 1. This configuration can prevent engagement of the cover 13 from being accidentally released even when tightening torque is applied to a screw terminal by wiring operation.

The torque applied to the screw terminal is tightening torque. Since tightening torque is generally greater than torque to loosen a screw terminal, engagement of the cover 13 is more likely to be accidentally released at the time of tightening a screw terminal. Therefore, taking measures against tightening torque enables engagement of the cover 13 to be effectively prevented from being accidentally released.

The projecting piece 22 is a snap-fit the tip portion 23 of which is formed in a hook shape. This configuration facilitates attachment and detachment of the cover 13.

Next, a comparative example will be described.

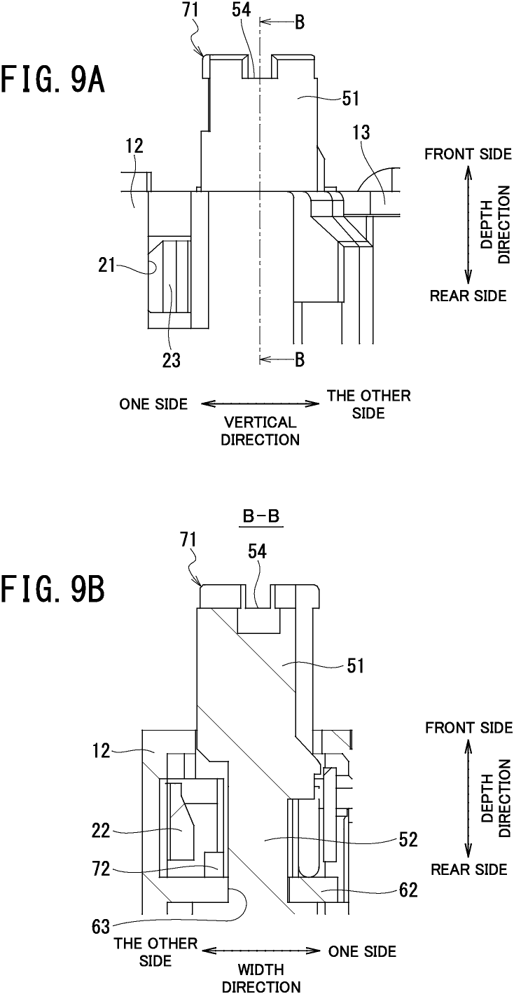

FIGS. 9A and 9B are diagrams illustrative of the comparative example.

FIG. 9A illustrates a case 12 to which a cover 13 is attached that is viewed from the other side in the width direction. FIG. 9B illustrates a cross section taken along the line B-B of FIG. 9A that crosses a reset bar 71 and extends in the width direction and the depth direction. The reset bar 71 includes a head portion 51 and a neck portion 52 and has a different shape from the shape of the reset bar 34 in the one embodiment. On the back side of the case 12, a barrier wall 72 is formed. When the reset bar 71 is positioned at an initial position, the outer peripheral surface of the neck portion 52 being opposed to the back side of a projecting piece 22 allows a tip portion 23 of the projecting piece 22 to be pushed inside, which enables the cover 13 to be removed from the case 12.

Therefore, there is a possibility that a force is exerted to the projecting piece 22 of the cover 13 when a screw terminal located close to an engagement hole 21 of the case 12 is tightened and the cover 13 accidentally comes off. This is because the other side in the vertical direction of the case 12 being firmly fixed to an electromagnetic contactor causes tightening torque to induce deformation on the projecting piece 22 of the cover 13. Accordingly, on the back side of the case 12, the barrier wall 72 to prevent the projecting piece 22 from bending is formed. There has been a problem in that, when configured as described above, it is required to destroy the projecting piece 22 to remove the cover 13, and the destroyed cover 13 cannot be reused. Further, there has also been a problem in that, when the projecting piece 22 is destroyed, a broken piece is left inside the case 12.

### (Variation)

Although the one embodiment was described using tightening torque as an example of torque applied to a terminal screw, the present invention is not limited to the example, and the present invention is also applicable to loosening torque.

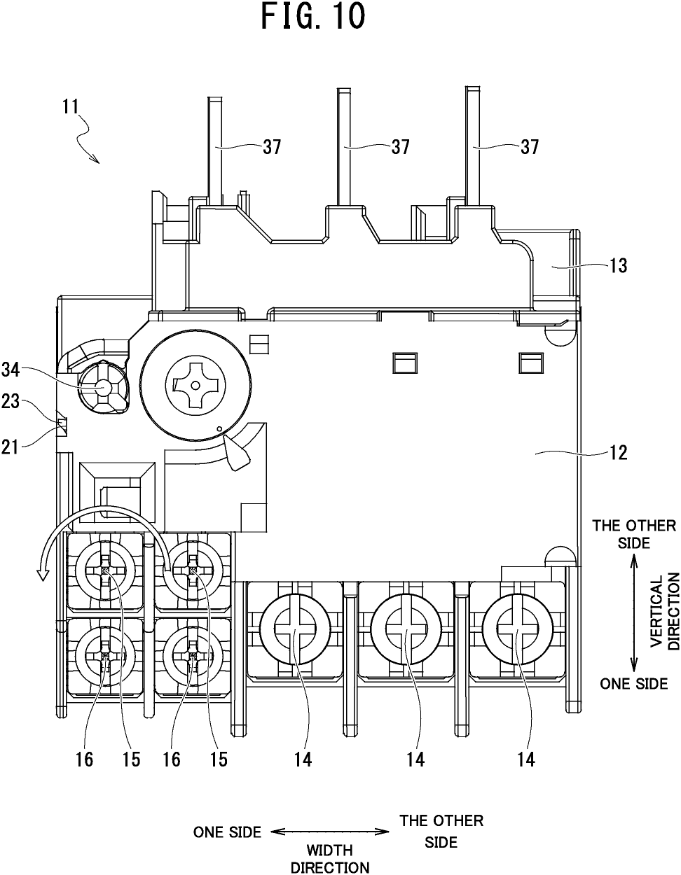

FIG. 10 is a diagram illustrative of a variation.

In the variation, the configuration of the thermal overload relay 11 is reversed in the width direction, and the side surface in which the engagement hole 21 is formed is a side surface on one side in the width direction. In this case, torque to loosen a screw terminal is exerted from the inner side to the outer side in the width direction on the open side of the case 12 when viewed from the front side in the depth direction. Therefore, there is a possibility that a force is exerted to the projecting piece 22 of the cover 13 when a screw terminal having been firmly tightened is loosened and the cover 13 accidentally comes off. Therefore, taking measures against loosening torque enables engagement of the cover 13 to be effectively prevented from being accidentally released.

While the present disclosure has been described with reference to the limited number of embodiments, the scope of the rights of the invention is not limited thereto. It will be obvious to those skilled in the art that various changes and modifications may be made in the embodiments based on the above disclosure.

REFERENCE SIGNS LIST

| | |
|---|---|
| 11 | Thermal overload relay |
| 12 | Case |
| 13 | Cover |
| 14 | Main terminal |
| 15 | Auxiliary terminal |
| 16 | Auxiliary terminal |
| 21 | Engagement hole |
| 22 | Projecting piece |
| 23 | Tip portion |
| 31 | Bimetal |
| 32 | Shifter |
| 33 | Reversal mechanism |
| 34 | Reset bar |
| 36 | Heater |
| 37 | Connection terminal |
| 41 | Compensation bimetal |
| 42 | Release lever |
| 43 | Tension spring |
| 44 | Movable plate |
| 45 | Plate spring |
| 46 | Interlocking plate |
| 47 | Plate spring |
| 51 | Head portion |
| 51 a | Projecting portion |
| 52 | Neck portion |
| 53 | Bottom portion |
| 54 | Cross-shaped groove |
| 55 | Recessed portion |
| 56 | Latch portion |
| 57 | Base piece |
| 61 | Recessed groove |
| 62 | Partition wall |
| 63 | Recessed groove |
| 71 | Reset bar |
| 72 | Barrier wall |

1. A thermal overload relay comprising:
a case on which a screw terminal having an axial direction aligned with a depth direction is disposed and in a side surface of which in a width direction when viewed from the depth direction an engagement hole is formed;
a cover on which a projecting piece projecting toward the case is formed and to be attached to the case by a tip portion of the projecting piece being fitted into the engagement hole from an inside; and
a reset bar having an axial direction aligned with the depth direction and configured to, when displaced to a manual reset position, the manual reset position being a position to which the reset bar is only displaced by being pushed from a front side in the depth direction serving as an initial position to a rear side in the depth direction, restore the thermal overload relay from a tripped state and, when displaced to an automatic reset position, the automatic reset position being a position at which a position in the depth direction of the reset bar is maintained by the reset bar being pushed and displaced from the initial position to a rear side in the depth direction and being rotated about an axis, automatically restore the thermal overload relay from the tripped state,
wherein the reset bar has a recessed portion formed in a preset range extending in the depth direction and a circumferential direction within an outer peripheral surface of the reset bar and, when positioned at either the initial position or the automatic reset position, prevents the tip portion from being pushed inside by having the outer peripheral surface opposed to the projecting piece and, when positioned at the manual reset position, allows the tip portion to be pushed inside by having the recessed portion opposed to the projecting piece.

2. The thermal overload relay according to claim 1, wherein the case opens to a side to be connected to an electromagnetic contactor, and the side surface is a side surface on, between one side and the other side in the width direction, a side on which torque applied to the screw terminal is exerted from an inner side to an outer side in the width direction on an open side of the case when viewed from a front side in the depth direction.

3. The thermal overload relay according to claim 2, wherein torque applied to the screw terminal is tightening torque.

4. The thermal overload relay according to claim 1, wherein the projecting piece is a snap-fit having the tip portion formed in a hook shape.

5. The thermal overload relay according to claim 2, wherein the projecting piece is a snap-fit having the tip portion formed in a hook shape.

6. The thermal overload relay according to claim 3, wherein the projecting piece is a snap-fit having the tip portion formed in a hook shape.
